(19) United States
(12) Patent Application Publication
(10) Pub. No.: US 2014/0298267 A1
(43) Pub. Date: Oct. 2, 2014

(54) NAVIGATION OF LIST ITEMS ON PORTABLE ELECTRONIC DEVICES

(71) Applicant: MICROSOFT CORPORATION, Redmond, WA (US)

(72) Inventors: Julian Chan, Seattle, WA (US); LiJuan Qin, Seattle, WA (US)

(73) Assignee: Microsoft Corporation, Redmond, WA (US)

(21) Appl. No.: 13/854,974

(22) Filed: Apr. 2, 2013

(51) Int. Cl. G06F 3/0482

(52) U.S. Cl. CPC G06F 3/0482
USPC 715/841

(57) ABSTRACT

Various techniques of navigation of messages or other items in a list are disclosed herein. In one embodiment, a method includes receiving a user navigation input to a list of messages displayed on the portable electronic device and detecting user intention to access additional messages in the list based on the received user navigation input. If the user intention is detected, displaying one or more interface representations on the display. Each of the interface representations corresponds to a subset of messages in the list.

### BACKGROUND

Mobile phones, smartphones, tablet computers, and other portable electronic devices typically display electronic messages, photos, or other items as a list or thread. For example, a smartphone can show a thread of text messages arranged according to a time of reception or transmission. The smartphone, however, can only show a few most recent messages in the thread at once due to a limited display area. To access additional text messages in the thread, a user may have to scroll up or down in order to locate a desired text message.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects of the present technology are directed to efficient navigation of messages, photos, or other suitable items in a list on mobile phones, smartphones, tablet computers, or other portable electronic devices. In certain embodiments, a portable electronic device may monitor for and detect user intention for accessing additional items not currently displayed based on a current position of an item displayed on the portable electronic device. For example, a current position of the item may correspond to a position (e.g., 10^{th}) and/or a time of reception or transmission (e.g., 1 day ago) relative to the most recent item. If the position and/or time are greater than a corresponding threshold, the portable electronic device may indicate that a user intends to visit additional items.

If user intention is detected, the portable electronic device may display a previously hidden directory interface object (e.g., a list header) to the user. Upon actuation of the directory interface object by the user, the portable electronic device can display a group directory showing a plurality of interface representations (e.g., graphical icons, pictures, images, etc.) individually associated with a subset of items in the list. The group directory may be organized based on a week, month, and/or year of creation, reception, or transmission, or based on other suitable criteria. Using the group directory, the user may then “jump” to a particular subset by selecting a corresponding interface representation to access desired items without scrolling through all of the messages.

### BRIEF DESCRIPTION OF THE DRAWINGS

FIG. 1 is a perspective view of a portable electronic device for facilitating navigation of list items in accordance with embodiments of the present technology.

FIG. 2 is a block diagram showing computing components suitable for the portable electronic device of FIG. 1 in accordance with embodiments of the present technology.

FIG. 3 is a block diagram showing software modules suitable for the portable electronic device of FIG. 2 in accordance with embodiments of the present technology.

FIG. 4 is a flow diagram illustrating a process for navigation of list items in accordance with embodiments of the present technology.

FIG. 5 is a flow diagram illustrating a process for navigation based on a group directory in accordance with embodiments of the present technology.

FIGS. 6A-6E are example renderings of a user interface during navigation of messages, as example items, in a list in accordance with embodiments of the present technology.

### DETAILED DESCRIPTION

Various embodiments of systems, components, modules, routines, and processes of navigation of messages in a list are described below. In the following description, example software codes, values, and other specific details are included to provide a thorough understanding of various embodiments of the present technology. As used herein, an “item” or a “list item” generally refers to an electronic file, a communication object, and/or other suitable types of software entity. For example, an item may include a photo, a video, a contact record, an application, a shortcut to an installed application, a voice recording, a document, a subset of a database such as a database entry, and/or other suitable types of file. In other examples, a list item may also include a text message, an email, a multimedia message, an instant message, an enhanced message, and/or other suitable communication object. A person skilled in the relevant art will also understand that the technology may have additional embodiments. The technology may also be practiced without several of the details of the embodiments described below with reference to FIGS. 1-6E.

As discussed above, a portable electronic device may present a limited number of messages or items in a list at once due to a limited display area. However, the list can include hundreds, if not thousands of items. As a result, scrolling through such a long list of items can be tedious and inefficient. One solution may include presenting navigation widgets (e.g., fast forward widgets) on a user interface to facilitate navigation of the messages. However, such navigation widgets can clutter the already limited display area of the portable electronic device.

Several embodiments of the present technology can address at least some of the foregoing challenges by monitoring for and detecting user intention to access additional items not currently displayed. Upon detection of the user intention, the portable electronic device may display a previously hidden directory interface object (e.g., a list header) to the user. Upon an input to or other interaction with the directory interface object by the user, the portable electronic device can display a group directory showing a plurality of interface representations individually associated with a subset of items in the list. As used herein, the term “interface representation” generally refers to an icon, picture, image, text string, and/or other depiction suitable to be displayed on a user interface of a computing device. The term “directory interface object” generally refers to an interface representation, upon an input to or other interaction by a user, that can cause displaying of a group directory, for example, having the plurality of interface representations individually associated with a subset of items in the list on the portable electronic device. Using the group directory, the user may then “jump” to a particular subset to access additional items without scrolling through all of the items in the list. Several embodiments of the present technology can thus improve usability over conventional techniques without cluttering the display area of the portable electronic device.

FIG. 1 is a perspective view of a portable electronic device 120 for facilitating navigation of items in accordance with embodiments of the present technology. The portable electronic device 120 can be a mobile phone, a smartphone, a personal data assistant, a tablet computer, and/or other suitable computing device. As shown in FIG. 1, the portable electronic device 120 includes a housing 121 carrying a display 124 (e.g., a touchscreen) and an input button 125. In other embodiments, the portable electronic device 120 can also include a front-facing camera, a rear-facing camera, a microphone, a speaker, an antenna, a keyboard, and/or other suitable electronic and/or mechanical components (not shown) in addition to or in lieu of the components shown in FIG. 1.

In operation, the portable electronic device 120 can transmit and/or receive messages to and from a user. As used herein, the term “messages” generally refers to text messages, emails, multimedia messages, enhanced messages, instant messages, and/or other suitable electronic communication objects. For example, the user 101 can compose a text message using the display 124 and/or the input button 125. The portable electronic device 120 can then transmit the composed text message to one or more other users and/or devices. In other examples, the user can also create or receive photos, videos, voice recordings, documents (text files, spreadsheets, etc.), and/or other suitable items on the portable electronic device 120.

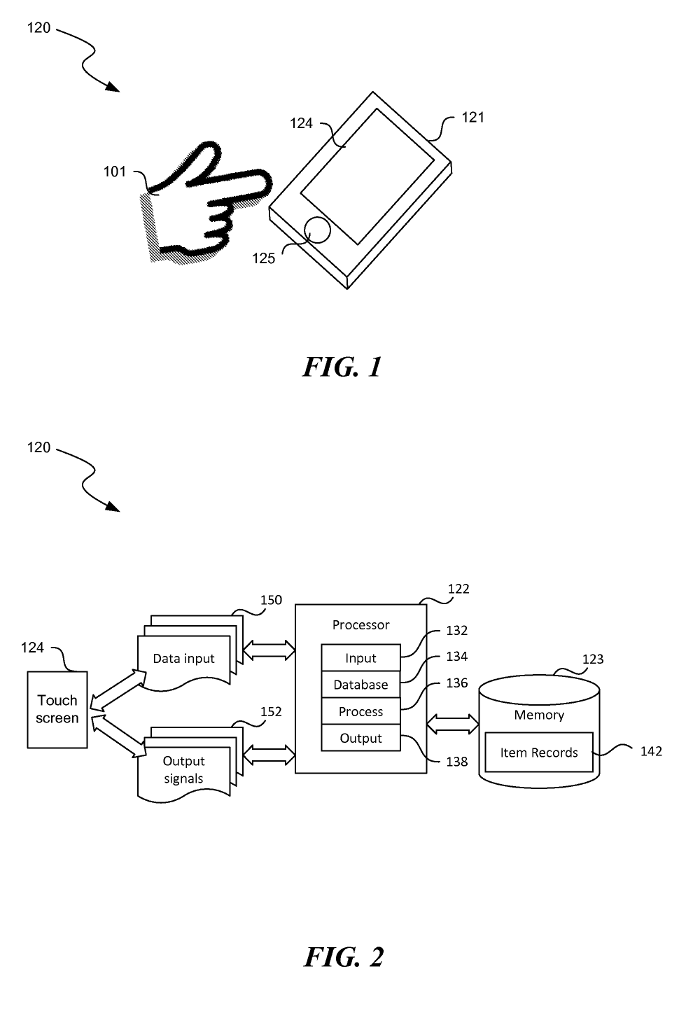

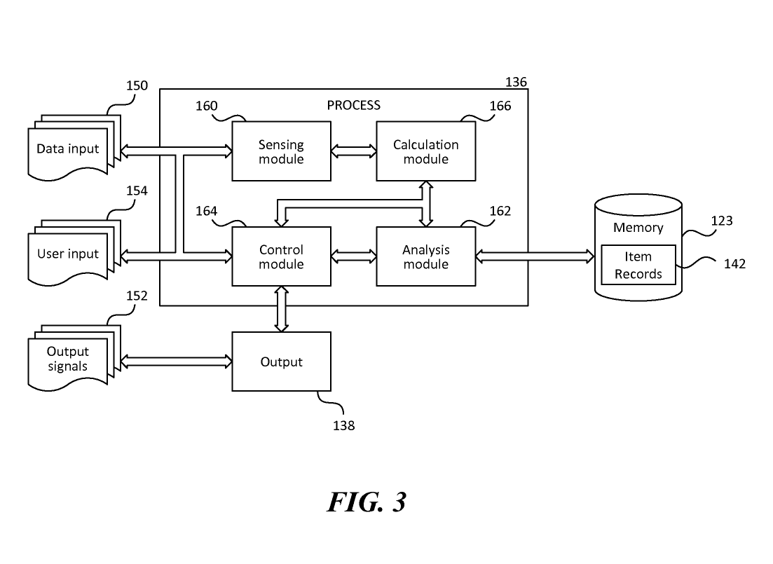

The portable electronic device 120 can also display items to the user. For example, the portable electronic device 120 can display a list or thread of text messages arranged by a time of reception or transmission on the display 124. Due to a limited area on the display 124, the portable electronic device 120 can only display a limited number of messages (e.g., most recently received messages) on the display 124 at once. However, from time to time, the user may desire to visit additional text messages. As discussed in more detail below with reference to FIGS. 2 and 3, the portable electronic device 120 can also include a processor 122 and a memory 123 (both shown in FIG. 2) that contains instructions to facilitate efficient navigation of additional text messages (or other suitable types of items) in the list.

FIG. 2 is a block diagram showing computing components suitable for the portable electronic device 120 of FIG. 1 in accordance with embodiments of the present technology. In FIG. 2 and in other Figures hereinafter, individual software components, modules, and routines may be a computer program, procedure, or process written as source code in C, C++, Java, and/or other suitable programming languages. The computer program, procedure, or process may be compiled into object or machine code and presented for execution by one or more processors of a computing device. Various implementations of the source, intermediate, and/or object code and associated data may be stored in a computer memory that includes read-only memory, random-access memory, magnetic disk storage media, optical storage media, flash memory devices, and/or other suitable computer readable storage media. As used herein, the term “computer readable storage medium” excludes propagated signals.

As show in FIG. 2, the portable electronic device 120 can include a processor 122 and a memory 123 operatively coupled to one another and to the display 124. The processor 122 can include a microprocessor a field-programmable gate array, and/or other suitable logic devices. The memory 123 can include volatile and/or nonvolatile computer readable storage media (e.g., ROM; RAM, magnetic disk storage media; optical storage media; flash memory devices, EEPROM, and/or other suitable storage media) configured to store data received from, as well as instructions for, the processor 122.

The processor 122 can be configured to execute instructions of software components stored in the memory 123. For example, as shown in FIG. 2, software components of the processor 122 can include an input component 132, a database component 134, a process component 136, and an output component 138 interconnected with one another. In other embodiments, the processor 122 may execute instructions of other suitable software components in addition to or in lieu of the foregoing software components.

In operation, the input component 132 can accept input data 150 (e.g., user input via the display 124 and/or the input button 125 in FIG. 1), and communicates the accepted input data 150 to other components for further processing. The database component 134 organizes records, including item records 142, and facilitates storing and retrieving of these records to and from the memory 123. The item records 142 may individually include a sender, a receiver, a time of reception or transmission, a message body, and/or other suitable information. Any type of database organization may be utilized, including a flat file system, hierarchical database, relational database, or distributed database. The process component 136 analyzes the input data 150 from the input module 132 and/or other data sources to facilitate user navigation of additional messages. The output module 138 generates output signals 152 based on the analyzed input data 150 and transmits the output signals 152 for display on the display 124. Embodiments of the process component 136 are described in more detail below with reference to FIG. 3.

FIG. 3 is a block diagram showing embodiments of the process component 136 in FIG. 2. As shown in FIG. 3, the process module 136 may further include a sensing module 160, an analysis module 162, a control module 164, and a calculation module 166 interconnected with one other. Each of the modules 160, 162, 164, and 166 may be a computer program, procedure, or routine written as source code in a conventional programming language, or one or more modules may be hardware modules.

The sensing module 160 is configured to receive the input data 150 and convert the input data 150 into types of user inputs. For example, the sensing module 160 may receive a user input representing a travel distance of the user's finger(s) and a duration of persistent touch. The sensing module 160 can then compare the duration of persistent touch to a predetermined threshold. If the duration is greater than the predetermined threshold, the analysis module 162 may indicate that the input is a scroll. In further example, the sensing module 160 may convert the input data 150 into a touch, a click, a double click, a page up, a page down, and/or other suitable types of input.

The calculation module 166 may include routines configured to perform various types of calculations to facilitate operations of other modules. In one example, the calculation module 166 can include a division routine that calculates an average speed of the user's scroll by dividing the travel distance by the duration of persistent touch. In another example, the calculation module 166 can include a differentiation routine that calculates an acceleration of the user's scroll by differentiating the average speed with respect to time. In further examples, the calculation module 166 can include linear regression, polynomial regression, interpolation, extrapolation, and/or other suitable subroutines. In further examples, the calculation module 166 can also include counters, timers, and/or other suitable routines.

The analysis module 162 can be configured to analyze the various sensed and/or calculated user inputs to detect user intention to visit additional items. In certain embodiments, the analysis module 162 can determine a position (e.g., 11^{th}) and/or a time of reception or transmission (e.g., 2 day ago) of the top most or bottom most items that is currently displayed on the display 124 (FIG. 1) relative to the most recent item. If the position or time is higher than a position threshold (e.g., 10^{th}) or a time threshold (e.g., 1 day ago), respectively, the analysis module 162 may determine that the user has scrolled for at least a predetermined scrolling distance. Thus, the analysis module 162 may indicate that the user intends to visit additional items. In other embodiments, the analysis module 162 can compare an average speed of the scroll to a predetermined speed threshold. If the average speed of the scroll is higher than the speed threshold, the analysis module 162 may indicate that the user intends to visit additional items. In further embodiments, the analysis module 162 may indicate that the user intends to visit additional items based on a combination of the previous conditions and/or other suitable conditions.

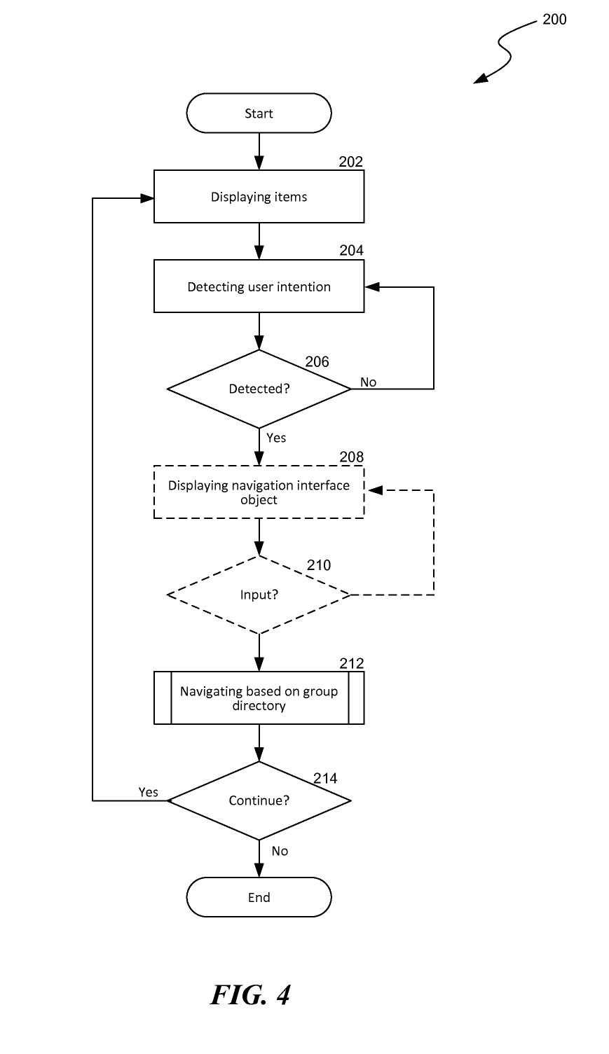

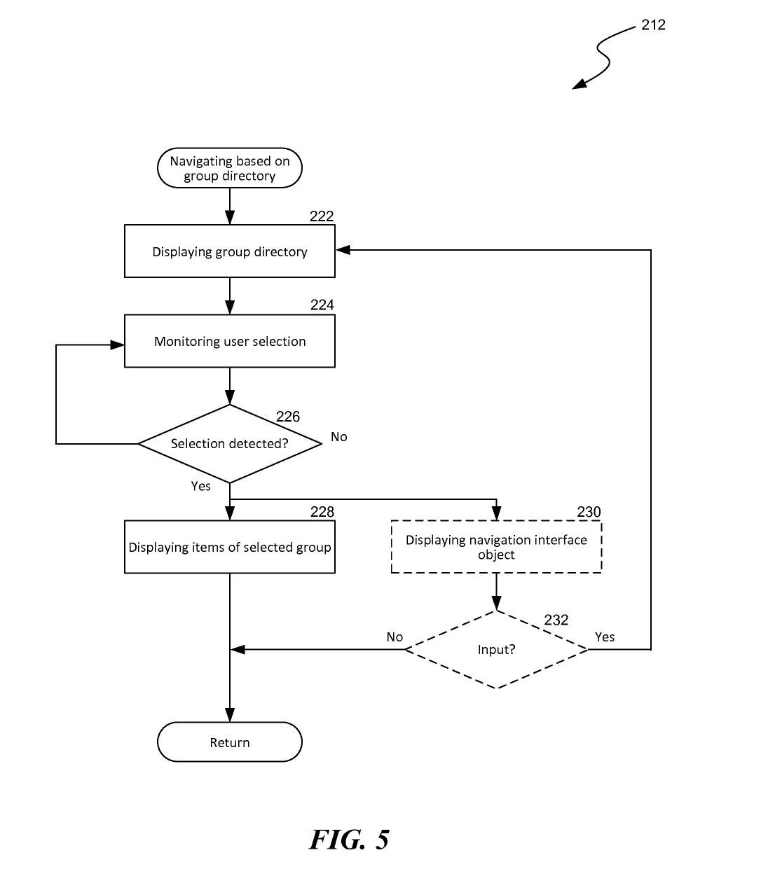

The control module 164 may be configured to control navigation of items in a list on the portable electronic device 120 (FIG. 1) based on the analysis results from the analysis module 162. For example, in one embodiment, the analysis module 162 indicates that the user intends to visit additional items. In response, the control module 164 can transmit the output signals 152 to the display 124 to display a directory interface object. If user input 154 to the directory interface object is detected, the control module 164 may then transmit additional output signals 152 to the display 124 to display a group directory showing a plurality of groups, each of which is individually associated with a subset of additional items. The groups may be organized based on a week, a month, and/or a year of reception or transmission, recipients'/senders' names, contact names, contact groups, application names, file names/directories, file types, dates of creation/modification, file sizes, and/or based on other suitable criteria. The displayed group directory can allow the user to navigate directly into one of the groups without scrolling through all the items, as described in more detail below with reference to FIGS. 4 and 5.

FIG. 4 is a flowchart showing a process 200 for using a portable electronic device for navigation of items in a list in accordance with embodiments of the present technology. Even though the process 200 is described below with reference to the portable electronic device 120 of FIGS. 1 and the software components/modules of FIGS. 2 and 3, the process 200 may also be applied in other systems with additional or different hardware and/or software components.

As shown in FIG. 4, the process 200 includes displaying one or more items in a list to a user on the portable electronic device 120. In certain embodiments, the displayed one or more items are the most recently received or transmitted items. The list can include additional items not currently displayed on the portable electronic device 120. The additional items can predate the displayed one or more items. In other embodiments, the displayed one or more items may include other suitable items. The user can then provide a navigation input to the displayed list of items. For example, the user may scroll up, scroll down, and/or otherwise navigate the items in the list. In response, the displayed items may be shifted up, shifted down, and/or otherwise adjusted based on the user navigation input.

At stage 204, the process 200 includes detecting user intention to visit additional, currently not displayed items in the list by monitoring user browsing inputs. In certain embodiments, detecting user intention includes monitoring a position and/or time of reception or transmission for the top most or bottom most item in the list relative to the most recent item. In other embodiments, detecting user intention can also include monitoring a scroll distance, a scroll speed, a scroll acceleration, and/or other suitable rendering characteristics of the displayed items. As used herein, the term “rendering characteristic” generally refers to a display action (e.g., scrolling), profile (e.g., position of the top most or bottom most displayed item), and/or other feature of the displayed items in the list. For example, monitoring a scroll acceleration may include monitoring for a rapid upward or downward slide movement of the user's finger, which is commonly referred to as a “flick.” In other examples, monitoring a scroll speed or scroll acceleration can include monitoring for hovering, hand waving, and/or other suitable user gestures.

Based on the monitored position and/or time of reception or transmission for the top most or bottom most item, scroll distance, a scroll speed, a scroll acceleration, and/or other suitable rendering characteristics, the portable electronic device 120 can determine if the user intends to visit additional items. For example, in one embodiment, if the monitored position of the top most or bottom most item is greater than a position threshold, the process 200 may indicate that user intention is detected. In another embodiment, if the monitored time is earlier than a time threshold, the process 200 may indicate that such user intention is detected. In yet another embodiment, if the scroll distance, scroll speed or scroll acceleration is higher than a corresponding threshold, the process 200 may indicate that such user intention is detected. In further embodiments, the process 200 may indicate that such user intention is detected based on a combination of the foregoing conditions and/or other suitable conditions.

At stage 206, if no user intention to visit additional items is detected, the process 200 reverts to detecting user intention to visit additional, currently not displayed items in the list at stage 204; otherwise, the process 200 precedes to an optional stage 208 in which a previously hidden directory interface object is displayed. In certain embodiments, the directory interface object can include a list header, e.g., a month and year in which the currently displayed items were received or transmitted. In other embodiments, the directory interface object may include a widget, a button, a link, and/or other suitable types of interface object that may be used to display a group directory of the list items.

At optional stage 210, a decision is made to determine whether a user has provided input to or otherwise interacted with the displayed directory interface object. If the user has not actuated or otherwise interacted with the displayed directory interface object, the process 200 reverts to displaying the interface object at stage 208; otherwise, the process 200 proceeds to stage 212 in which navigation of items based on a group directory is enabled, as described in more detail below with reference to FIG. 5. In other embodiments, displaying the directory interface object at stage 208 and monitoring input to the displayed directory interface object at stage 210 may be omitted, and the process 200 may proceed directly from stage 206 to navigating based on a group directory at stage 212.

The process 200 then includes a decision stage 214 to determine whether the process continues. In one embodiment, the process 200 continues if the user continues to interact with the items. In other embodiments, the process 200 continues if some of the items are still displayed. In further embodiments, the process 200 can continue based on other suitable conditions. If the process continues, the process 200 reverts to detecting user intention to visit additional, currently not displayed items in the list at stage 204; otherwise, the process ends.

FIG. 5 is a flow diagram illustrating a process 212 for navigation based on a group directory in accordance with embodiments of the present technology. As shown in FIG. 5, the process 212 can include displaying a group directory at stage 222. The group directory can include a plurality of groups with each group individually having a subset of items. In one embodiment, the subsets of items may be categorized based on a time/date of reception or transmission. For example, items received/transmitted during a particular month (e.g., December) in a year (e.g., 2012) may be organized into one subset. Items received/transmitted during another month (e.g., November) in the same year (e.g., 2012) may be organized into another subset. In other embodiments, the subset of items may be categorized based on at least one of a sender, a receiver, a subject matter, keywords, alphabetically, and/or other suitable criteria.

At stage 224, the process 212 includes monitoring user selection of the group directory. If no selection is detected, the process 212 reverts to monitoring user selection at stage 224. If user selection of a particular group is detected, the process 212 includes displaying items of the selected group at stage 228. In one embodiment, the displayed items are arranged with the earliest message displayed first. In another embodiment, the displayed items are arranged with the most recent message displayed first. In further embodiments, the displayed items can be arranged in other suitable manners.

As shown in FIG. 5, the process 212 can optionally include displaying a directory interface object in the displayed items of the selected group at stage 230, generally similar to stage 208 in FIG. 4. At optional stage 210, a decision is made to determine whether the user has actuated the displayed interface object. If the user has actuated the displayed interface object, the process 212 reverts to displaying the group directory at stage 222; otherwise the process 212 returns.

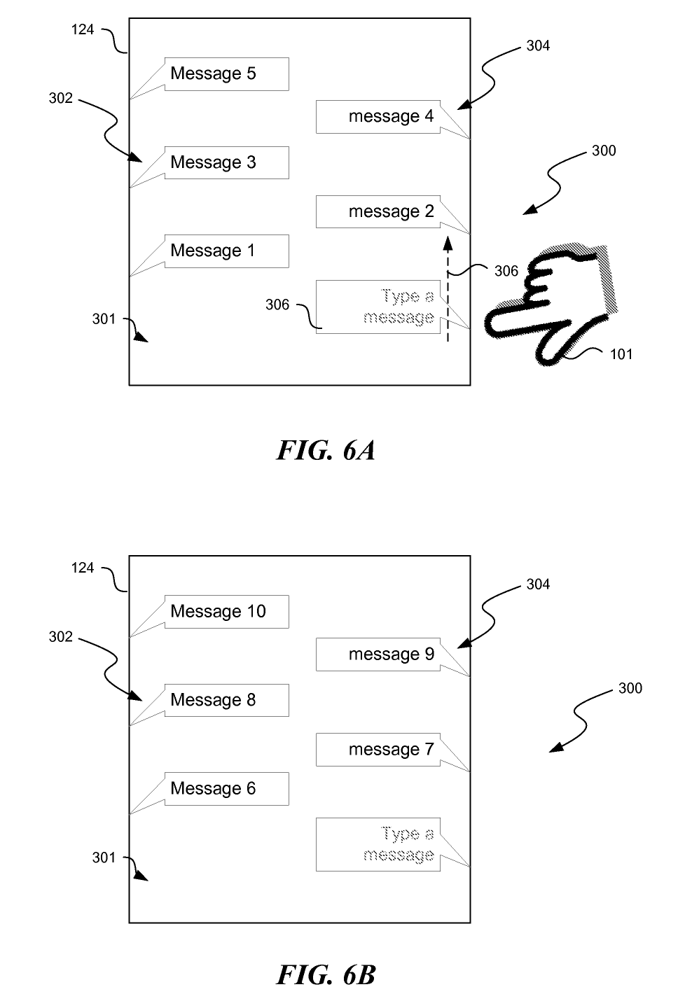

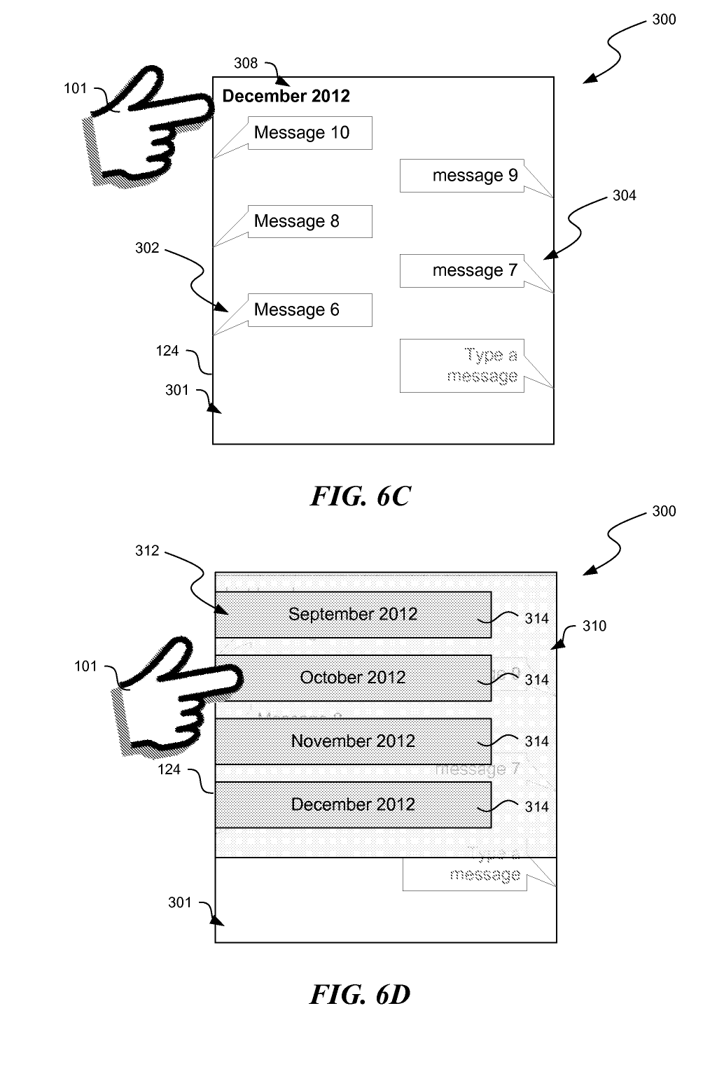

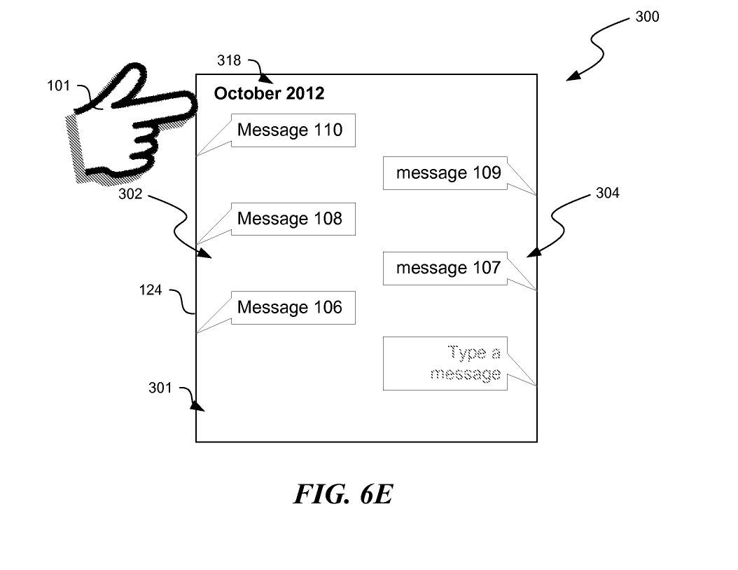

FIGS. 6A-6E are example renderings of a user interface on a portable electronic device during navigation of messages, as example items, in a list in accordance with embodiments of the present technology. Even though navigation of messages is described below to illustrate aspects of the present technology, in other embodiments, the present technology may also be applied to navigation of a contact list, an application list, and/or other types of list with a plurality of list items. As shown in FIG. 6A, the display 124 can include a display area 301. In the illustrated embodiment, multiple inbound messages 302 (i.e., messages 1, 3, and 5) and outbound messages 304 (i.e., messages 2 and 4) are displayed within the display area 301. The inbound and outbound messages 302 and 304 are collectively referred to as messages 300. The display area 302 also includes an input box for facilitating composition of a new message.

During operation, a user 101 may scroll the messages 300 as indicated by arrow 306. In response, as shown in FIG. 6B, the portable electronic device can display additional messages 300 (i.e., messages 6-10). As described above with reference to FIG. 4, if user intention to visit additional messages is detected, as shown in FIG. 6C, a directory interface object 308 may be displayed. In the illustrated embodiment, the directory interface object 308 includes a list header showing a month (i.e., December) and a year (i.e., 2012) in which the messages 300 were dated. In other embodiments, the directory interface object 308 can include other suitable interface representations.

If the user 101 actuates, by touching or otherwise interacting with the displayed directory interface object 308, as shown in FIG. 6D, a directory display area 310 may be shown, for example, as superimposed on the display area 301. The directory display area 310 may include a group directory 312 having a plurality of interface representations 314 of groups individually associated with a subset of messages. For example, in the illustrated embodiment, the groups individually include a subset of messages categorized based on dates of reception or transmission (i.e., September 2012, October 2012, November 2012, and December 2012).

Upon the user 101 selecting one of the displayed interface representations 314 (e.g., October 2012), as shown in FIG. 6E, messages received or transmitted during October 2012 can be displayed in the display area 301, and the displayed group directory 312 may be removed. In the illustrated embodiment, a new optional directory interface object 318 (“i.e., October 2012) is also displayed. The new directory interface object 318 can be generally similar to the directory interface object 308 in FIG. 6C. Thus, if the user 101 actuates the new directory interface object 318, the directory display area 310 (FIG. 6D) may be displayed again. In other embodiments, the new directory interface object 318 may be omitted.

Specific embodiments of the technology have been described above for purposes of illustration. However, various modifications may be made without deviating from the foregoing disclosure. In addition, many of the elements of one embodiment may be combined with other embodiments in addition to or in lieu of the elements of the other embodiments. Accordingly, the technology is not limited except as by the appended claims.

I/We claim:

1. A portable electronic device having a processor, a display, and a computer readable storage medium containing instructions, when executed by the processor, causing the processor to perform a method comprising:
displaying one or more items in a list on the display;
monitoring a rendering characteristic of the one or more displayed items;
detecting user intention to visit other items in the list based on the monitored rendering characteristic; and
when the user intention to visit other items is detected, displaying a group directory on the display, the group directory having one or more interface representations each individually corresponding to a subset of items in the list.

2. The portable electronic device of claim 1 wherein monitoring a rendering characteristic includes monitoring at least one of a position or a time of reception or transmission of one of the displayed items.

3. The portable electronic device of claim 1 wherein:
monitoring a rendering characteristic includes monitoring at least one of a position or a time of reception or transmission of one of the displayed items;
detecting user intention includes
performing a first comparison of the monitored at least one of the position to a position threshold, or performing a second comparison of the time of reception or transmission to a time threshold; and
indicating the user intention to visit additional items based on at least one of the first or second comparison.

4. The portable electronic device of claim 1 wherein:
monitoring a rendering characteristic includes monitoring a position of a top most item of the displayed items;
detecting user intention includes
comparing the monitored position of the top most item to a position threshold; and
indicating the user intention to visit additional items when the monitored position of the top most item exceeds the position threshold.

5. The portable electronic device of claim 1, further comprising:
receiving a user input to select one of the interface representations in the displayed group directory; and
replacing the one or more items displayed on the portable electronic device with a subset of items corresponding to the selected interface representation.

6. The portable electronic device of claim 1 wherein:
the displayed one or more items are most recent items;
the method further comprises:
receiving a user input to select one of the interface representations in the displayed group directory; and
replacing the one or more items displayed on the portable electronic device with a subset of items corresponding to the selected interface representation; and
the subset of items predates the most recent items.

7. The portable electronic device of claim 1 wherein:
displaying a group directory includes superimposing the group directory onto the displayed one or more items;
the method further comprising:
receiving a user input to select one of the interface representations in the displayed group directory;
removing the displayed group directory; and
replacing the one or more items displayed on the portable electronic device with a subset of text items corresponding to the selected interface representation.

8. A method performed by a processor of a portable electronic device, the method comprising:
receiving a user navigation input to a list of items displayed on the portable electronic device;
detecting user intention to access additional items in the list based on the received user navigation input; and
when the user intention is detected, displaying one or more interface representations on the display, each of the interface representations corresponding to a subset of items in the list.

9. The method of claim 8 wherein receiving a user navigation input includes receiving a scrolling input.

10. The method of claim 8 wherein:
receiving a user navigation input includes receiving a scrolling input; and
the method further includes determining a scrolling distance corresponding to the scrolling input.

11. The method of claim 8 wherein:
receiving a user navigation input includes receiving a scrolling input;
the method further includes determining a scrolling distance corresponding to the scrolling input; and
detecting user intention includes
comparing the scrolling distance to a threshold;
when the scrolling distance exceeds the threshold, indicating the user intention is detected.

12. The method of claim 8 wherein:
receiving a user navigation input includes receiving a scrolling input;
the method further includes determining a scrolling distance corresponding to the scrolling input by determining a position of an earliest item in the displayed items relative to a most recent item in the list; and
detecting user intention includes
comparing the position to a threshold;
when the position exceeds the threshold, indicating the user intention is detected.

13. The method of claim 8 wherein the individual subsets of items are categorized by a time of reception or transmission, and wherein displaying one or more interface representations includes displaying one or more interface representations each individually corresponding to a time period of reception or transmission.

14. The method of claim 8 wherein:
the individual subsets of items are categorized by a time of reception or transmission;
displaying one or more interface representations includes displaying one or more interface representations individually corresponding to a time period of reception or transmission; and
the method further includes
receiving a user input to select one of the interface representations; and
replacing the displayed list of items with a subset of items corresponding to the selected interface representation.

15. The method of claim 8 wherein:
the individual subsets of items are categorized by a time of reception or transmission;
displaying one or more interface representations includes displaying one or more interface representations individually corresponding to a time period of reception or transmission; and
the method further includes
receiving a user input to select one of the interface representations;
removing the displayed interface representations; and
replacing the displayed list of items with a subset of items corresponding to the selected interface representation.

16. A computer readable storage medium containing instructions, when executed by a processor, causing the processor to perform a method comprising:
displaying a plurality of text messages in a list on a display operatively coupled to the processor;
receiving a user navigation input to the displayed list of messages;
adjusting display of the messages based on the user navigation input;
determining a rendering characteristic of the adjusted display of the messages;
detecting user intention to access additional messages in the list based on the determined rendering characteristic;
when the user intention is detected, displaying a previously hidden list header of the list of messages;
receiving a user input to the displayed list header;
in response to the received user input, displaying a group directory on the display, the group directory having one or more interface representations individually corresponding to a subset of messages in the list.

17. The computer readable storage medium of claim 16 wherein:
receiving a user navigation input includes receiving a scrolling input;
adjusting display of the messages includes scrolling the displayed messages based on the received scrolling input;
determining a rendering characteristic includes determining a scrolling distance corresponding to the scrolling input by determining a position of an earliest message in the displayed messages relative to a most recent message in the list; and
detecting user intention includes
comparing the scrolling distance to a threshold;
when the scrolling distance exceeds the threshold, indicating the user intention is detected.

18. The computer readable storage medium of claim 16 wherein:
receiving a user navigation input includes receiving a scrolling input;
adjusting display of the messages includes scrolling the displayed messages based on the received scrolling input;
determining a rendering characteristic includes determining a scrolling distance corresponding to the scrolling input by determining a position of an earliest message in the displayed messages relative to a most recent message in the list; and
detecting user intention includes
comparing the position to a threshold;
when the position exceeds the threshold, indicating the user intention is detected.

19. The computer readable storage medium of claim 16 wherein the list header is a first list header and the user input is a first user input, and wherein the method further includes:
receiving a second user input to select one of the interface representations;
removing the displayed interface representations; and
replacing the displayed list of messages with a subset of messages corresponding to the selected interface representation and a second list header different than the first list header.

20. The computer readable storage medium of claim 16 wherein the list header is a first list header and the user input is a first user input, and wherein the method further includes:
receiving a second user input to select one of the interface representations;
removing the displayed interface representations;
replacing the displayed list of messages with a subset of messages corresponding to the selected interface representation and a second list header different than the first list header;
receiving a third user input to the second list header; and
in response to the received third user input, displaying the group directory on the display over the subset of messages corresponding to the selected interface representation.
